(19) United States
(12) Patent Application Publication
(10) Pub. No.: US 2009/0054232 A1
(43) Pub. Date: Feb. 26, 2009

(54) Film-Like composition containing a sorbent

(76) Inventors: Stefan Dick, Weichering (DE); Mandy Erdmann, Landshut (DE); Inge Kramer, Freising (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(21) Appl. No.: 11/596,692

(22) PCT Filed: May 10, 2005
(86) PCT No.: PCT/EP2005/005050

§ 371 Date: Jan. 12, 2007

(30) Foreign Application Priority Data
May 18, 2004 (DE) 10 2004 024 676.9

(51) Int. Cl. B01J 20/26

(52) U.S. Cl. 502/402

(57) ABSTRACT

The present invention relates to a film-like uncompressed composition, in particular for moisture-sensitive electronic components or devices, comprising at least one sorbent (component A); at least one natural or synthetic sheet silicate (component B); and, if desired, a liquid phase (component C), in particular water. Furthermore, a process for producing such a composition and its use are described.

The invention relates to film-like sorbent-containing compositions and preferably moisture-adsorbing films or layers which are present on supports or substrates and can be produced from sorbent-containing compositions.

The invention further relates to processes for producing such compositions or assemblies, films or layers and their use.

It is known that, for example, electroluminescent components function without problems over a prolonged period only when a desiccant is present. These desiccants are sometimes also referred to as “getters” in the prior art. The sensitivity of these components is attributable to the tendency of the cathodes in particular to be corroded in the presence of moisture. For this reason, these components are provided with a desiccant and are sealed as well as possible under protective gas.

There are generally a series of concepts known for pressing pulverulent moisture-adsorbing agents either to form pellets or shaped bodies so as to install these into the display housing in order to ensure a low atmospheric humidity or to pack the resulting desiccant granules in, for example, bags and install these gas-permeable bags in the display housing to ensure a low atmospheric humidity.

EP 500 382 A2 describes the use of a moisture absorber in an electroluminescent (EL) device. The desiccant in the form of a powder or small spheres is in this case applied to a black silicone resin coating. According to the preferred embodiment, the desiccant is packed in a gas-permeable bag.

U.S. Pat. No. 5,882,761 likewise describes the use of a desiccant in an electroluminescent device. Preference is given to using BaO as desiccant.

EP 0 776 147 A1 describes the use of alkali metal oxides, alkaline earth metal oxides, sulphates, metal halides and metal perchlorates as moisture absorbers in EL devices.

U.S. Pat. No. 5,401,536 describes a method of producing a moisture-free encapsulation for an electronic device, with the encapsulation having a coating or an adhesive having desiccant properties.

U.S. Pat. No. 5,591,379 describes the composition of a moisture absorber for hermetically sealed electronic devices. This moisture absorber is applied as a coating in the interior of the device, with the moisture absorber comprising a binder which is permeable to water vapour and the desiccant being embedded with the average particle size of 0.2-100 μm, preferably 0.3-50 μm. The desiccant is preferably a molecular sieve.

U.S. Pat. No. 6,226,890 describes a method of drying moisture-sensitive electronic components in a hermetic encapsulation, with the desiccants comprising solid grains having particle sizes of 0.1-200 μm. The desiccant grains are embedded in a binder. The binder can be present as a liquid phase or dissolved in a liquid phase. A castable mixture comprising at least the desiccant particles and the binder is produced, with this mixture containing 10-90% by weight of desiccant, based on the total mixture. This mixture is poured into the inside of a hermetic encapsulation in order then to form a desiccant film which is subsequently cured.

US 2003/0037677 A1 describes the use of desiccants such as barium oxide, calcium oxide, phosphorus pentoxide, magnesium perchlorate, calcium sulphate, molecular sieves, calcium bromide, calcium sulphate embedded in synthetic resins in sealed moisture-sensitive electronic devices. The particle size of the desiccant grains used is 0.001-0.1 μm. Particular preference is given to phosphorus pentoxide, calcium oxide, barium oxide and magnesium perchlorate. Polymeric binders used are polyethyl methacrylate, polydiallyl phthalate, polysulphone, phenoxy resins and UV-curing acrylates.

The desiccants known from the above documents have the disadvantage that they contain organic constituents in the form of binders and/or solvents. On curing of desiccant films produced from these preparations or thermal activation of these desiccant films, solvent residues and possibly fragments of the polymers used can pass in the form of monomers or short-chain oligomers into the gas phase. These organic contaminants damage electronic components based on organic compounds, in particular electroluminescent components.

DE 199 59 957 A1 describes platelet-shaped pressed bodies which are based on an inorganic sorbent and a binder and have a thickness of less than 700 μm and are obtainable by pressing a mixture of the inorganic sorbent with about 20-60% by weight of the binder and about 10-15% by weight of water, based on the total mixture, at a pressure of at least about 70 megapascal and calcining the green pressed body obtained at temperatures of at least about 500° C. until the water content has largely been removed. The pressed bodies produced in this way are used in electronic devices such as display devices, in particular in electro-luminescent components.

DE 100 65 946 A1 describes a platelet-shaped pressed body which is based on an inorganic sorbent and a binder and has a thickness of less than 700 μm and is obtainable by pressing a mixture of the inorganic sorbent, the binder, water and possibly pressing aids at a pressure of at least 70 megapascal, with the weight ratio of the dry sorbent to the dry binder in the mixture being from about 4 to 0.7 and the water content of the mixture at 160° C. being about 8-20%, and calcining the green pressed body obtained at temperatures of at least about 500° C. until the water content has largely been removed. The pressed bodies produced in this way are used in electronic devices such as display devices, in particular in electro-luminescent components.

The pressed bodies described in the above documents frequently have the disadvantage that, owing to their low thickness and ceramic properties, they are quite brittle and can break easily.

It is thus an object of the present invention to provide sorbent-containing compositions which avoid the disadvantages of the prior art and make possible a good sorption performance combined with good stability and simple production and application.

This object is achieved by provision of a film-like composition according to claim 1.

Thus, it has surprisingly been found that compositions comprising
a) at least one sorbent (component A);
b) at least one natural or synthetic sheet silicate (component B);
c) if desired, a liquid phase (component C), in particular water,
   can be processed particularly advantageously to produce highly active film- or layer-like sorbent compositions or coatings or films. The expression “film-like” is to be interpreted here in a wide sense as indicating that the composition is or can be applied in the form of a film or a layer to a support, in particular a solid, preferably rigid support.

The film-like composition is preferably produced without application of pressure. The compositions or assemblies of the invention are therefore not pressed bodies; the film-like compositions of the invention are not a compressed layer or pressed layer. It has been found that the films having the composition according to the invention can advantageously be applied without pressing or compression directly to the desired substrates, with porous desiccant films having a high water absorption capacity and good adhesion being able to be produced.

In a preferred embodiment, no shaping of the film-like composition in a mould to give a (pressed) shaped body is carried out either. Rather, the composition of the invention can be applied directly by means of the methods described below to the desired substrate at the desired place in the moisture-sensitive device.

The density of the (film-like) composition of the invention is less than 1.2 g/m³, in particular less than 1.1 g/m³, particularly preferably less than 1.0 g/cm³. A particularly preferred range is from about 0.4 to 1 g/cm³.

The dimensions of the film or the layer in terms of length, width and layer thickness can in principle be chosen freely and are generally restricted by the space available for application to the desired support or in the component of interest. An advantage of the invention is the great flexibility of the application and dimensioning of the composition of the invention and also the low brittleness and dust formation.

The films are preferably produced on (solid) substrates such as glass, plastic or metal which have proven to be suitable for the encapsulation of moisture-sensitive electronic components. However, it is also possible to use other supports/substrates depending on the application, in particular rigid or flexible substrates/supports. It is preferred that no adhesive is used in the application or fastening to the substrate. The application of the composition of the invention as a film to the substrate is thus effected directly without separate adhesion promoters or adhesive (layer). Adhesion is advantageously provided directly by the composition of the invention, with the film-like composition itself adhering to the substrate even after drying.

A typical film or layer thickness of the compositions of the invention is from 1 μm to 10 mm, preferably from about 5 μm to 1 mm, particularly preferably from about 10 μm to 500 μm, in particular from about 15 μm to 200 μm.

In a particularly preferred embodiment, the film-like compositions of the invention can be used in moisture-sensitive electronic components in which there is only limited room available and which may be exposed to physical shocks. Moisture-sensitive electronic components include, for example, display devices, organic light-emitting components (OLEDs) or elements, polymeric light-emitting components (LEDs), CCD sensors and microelectrical mechanical sensors (MEMSs).

In a preferred embodiment of the invention, the film-like composition does not contain any organic solvent or organic binder. The use of organic desiccants is also not preferred because of the problems with organic components described below. In particular, it is preferred that the film-like composition is free of any organic components. In some cases, it can be advantageous to mix small amounts of an organic preservative into the composition of the invention. However, the amount of organic components in the composition of the invention is preferably less than 0.5% by weight, in particular less than 0.3% by weight. Thus, it has been found for the purposes of the present invention that excellent sorbent materials can also be produced without such organic binders or solvents, so that numerous problems caused by the undesirable reaction or interaction of the organic components, in particular volatile components, with parts of the electronic components can at the same time be avoided.

For the purposes of the present invention, the expression “sorbent” is used both for adsorbents and for absorbents. All sorbent materials, regardless of the sorption mechanism, are encompassed. The at least one sorbent can be any sorbent which is known or is suitable to those skilled in the art. Apart from the sorption of water vapour, the sorption of other gaseous substances, e.g. ammonia, volatile amines or oxygen, is in principle also of interest here. Thus, for example, attack on the cathodes of an EL device can also be triggered by gases which, in addition to water, are formed in the setting of the binder or solvent used for sealing. In addition, the action of oxygen frequently leads to failure of luminescent components.

It is possible to use both organic and inorganic sorbents. Preference is given to using one or more inorganic sorbents. The sorbent is preferably a desiccant. In a particularly preferred embodiment of the invention, the at least one sorbent comprises a natural or synthetic zeolite. Further nonlimiting examples are amorphous silica, aluminium hydroxide, calcium oxide, barium oxide and calcium sulphate. It is also possible to use mixtures of two or more sorbents. However, organic sorbents are also encompassed in principle, for example those described in EP 1 014 758 A2, US 2002/0090531 A1 or US 2003/0110981.

According to the invention, the film-like composition does not contain any calcium chloride, since liquefaction of this desiccant on absorption of moisture can impair or damage both the film-like composition itself and also its adhesion to the substrate and thus also the moisture-sensitive device or the moisture-sensitive apparatus. Preference is also given to the film-like composition of the invention containing no components in general which liquefy on taking up moisture.

In a preferred embodiment of the invention, the D₅₀ of the sorbent used (component A), in particular the zeolite, is from about 2 to 8 μm, in particular from about 3 to 6 μm. The D₉₀ is preferably less than 15 μm, in particular in the range from 5 to 12 μm.

The film-like composition of the invention additionally contains at least one natural or synthetic sheet silicate. Thus, it has surprisingly been found that the use of at least one natural or synthetic sheet silicate makes it possible to provide a particularly advantageous porous matrix for the sorbent, which can simultaneously make excellent adhesion to various supports to which the film-like composition is to be applied possible. The presence of the at least one natural or synthetic sheet silicate surprisingly does not impair the sorption properties of the sorbent, but in many cases increases it. Furthermore, natural or synthetic sheet silicates themselves have a sorption potential for various polar and nonpolar substances which can advantageously be utilized in the film-like composition of the invention. Particular preference is given to two- or three-layer silicates, in particular smectitic sheet silicates such as bentonites or hectorites. It is also possible to use mixtures of two or more binders. Apart from the natural or synthetic sheet silicate, further binders can be additionally present. As further binders, it is in principle possible to use all preferably inorganic binders which appear suitable to a person skilled in this field, e.g. aluminium oxide hydroxide (pseudoboehmite), water glass, borates, low-melting or low-softening glasses or glass solders. The function of the binder is to produce film formation on the surface of the substrate used, to bind the particles of the sorbent used to one another and to produce a bond between the sorbent particles and the substrate (support) used. This ensures reliable adhesion of the sorbent film to the substrate and avoidance of the formation of particles. At the same time, the binder used has to be able to give the sorbent film a sufficient porosity which makes the embedded sorbent readily available to the substances to be taken up, e.g. water vapour.

The components A and B are preferably used in particulate form. The preferred sorbents such as zeolite A are obtainable in powder form and have, for example, a water content of from about 10 to 22% by weight. The preferred binders such as bentonite are likewise obtainable as powders and preferably have a water content of from about 3 to 20% by weight, in particular from about 8 to 12% by weight, in each case determined by drying at 160° C. The bentonite used has a montmorillonite content of preferably >80%, based on the dry state.

In a preferred embodiment of the invention, the D₅₀ of the sheet silicate used (component B) is from about 2 to 8 μm, in particular from about 3 to 6 μm. The D₉₀ is preferably less than 20 μm, in particular in the range from 10 to 18 μm.

It is also preferred that the component B contains no relatively large proportions, i.e. not more than about 10% by weight, in particular not more than about 5% by weight, particularly preferably 0% by weight, of particles larger than 250 μm, preferably larger than 200 μm, in particular larger than 150 μm (able to be determined by sieve analysis).

In a particularly preferred embodiment of the present invention, the natural or synthetic sheet silicate is a swellable sheet silicate. In particular, a swellability of at least 10 ml/2 g, preferably at least 15 ml/2 g, in particular in the range from about 20 ml/2 g to about 40 ml/2 g has been found to be particularly advantageous. It is assumed, without the invention being restricted to this theoretical assumption, that the swellability favourably influences the film formation properties of the compositions of the invention, the porosity of the matrix (after drying) for the sorbent and/or the adhesion properties.

The mean pore diameter (determined as pore size average pore diameter (4V/A by BET)) of the sheet silicate used (component B) is preferably in the range from about 3 to 15 nm, in particular from about 4 to 12 nm. In a preferred embodiment, the sheet silicate used contains from about 30 to 130 meq/100 g of Na⁺, in particular from about 50 to 120 meq/100 g of Na⁺, able to be determined by the ion exchange capacity (cf. “Methods”).

In a preferred embodiment of the present invention, the film-like composition is based essentially on the components A, B (and C, if present) according to claim 1, i.e. these components together make up more than 50% by weight, in particular more than 70% by weight, particularly preferably more than 90% by weight, of the film-like composition. In a further preferred embodiment, the film-like composition comprises more than 95% by weight, in particular more than 97.5% by weight, of the components A, B (and C, if present). Thus, according to an embodiment of the invention, the film-like composition consists essentially or entirely of the components A, B (and C, if present).

For the purposes of the present invention, the term “liquid phase” refers to any liquid which can serve as suspension medium for the component B. Accordingly, the liquid phase or liquid can also serve as suspension medium or solvent for the component A. The liquid phase is preferably used in the mixing of the components A and B to produce a paste or a slurry which is subsequently processed to give the film-like composition or applied to a support. The liquid is preferably an inorganic liquid, in particular water. However, it is also possible to use mixtures of various liquids.

It goes without saying that the film-like composition can be heated after application to the solid support to remove the liquid phase or, if appropriate, to activate the at least one sorbent (e.g. in the case of zeolite). Thus, the abovementioned percentages by weight naturally apply correspondingly to the components A and B of a film-like composition according to the invention after removal of the liquid phase, i.e. in a preferred embodiment of the invention, the film-like composition after removal of the liquid phase consists essentially or entirely of the components A and B.

In a preferred embodiment of the invention, the film-like compositions are produced with the aid of pastes or slurries based on an inorganic sorbent and an inorganic binder dispersed in a preferably inorganic liquid phase. For the purposes of the present invention, a mixture comprising the components A, B and C is firstly prepared, for example by simple mixing or stirring together. This mixture is preferably not a solid mixture or kneaded composition, but instead a liquid or fluid or castable composition. As a result, inter alia, easy and uniform application to the substrate is made possible and particularly advantageous adhesion is ensured.

The composition according to the invention (paste or slurry) used for application to the support or the substrate preferably has a solids content of from 15 to 40% by weight, preferably from 25 to 35% by weight. Furthermore, the composition of the invention or the paste or slurry from which it is derived preferably has a viscosity of from 10 to 7000 mPa*s, preferably from 10 to 6000 mPa*s, more preferably from 10 to 1000 mPa*s, in particular from 100 to 1000 mPa*s, more preferably from 200 to 500 mPa*s, at a shear rate of 100 s⁻¹ during application to the support. The viscosity is determined as indicated in the method section below. The pastes according to the invention preferably display no or only little syneresis or demixing or settling of individual components, a high storage stability and a viscosity suitable for the particular method of application. The preferred values indicated above for the solids content and the viscosity thus apply both to the composition of the invention prior to application to the substrate or the support and to the film-like composition which has been applied to the substrate or the support (before drying).

The proportions of the sorbent (component A) and of the natural or synthetic sheet silicate (component B) can generally vary within wide limits. For example, the proportion of sorbent can be 10-90% by weight of the total composition.

In a preferred embodiment of the invention, the film-like composition has the following weight ratios: component A: from 20 to 50 parts by weight, in particular from 25 to 45 parts by weight; component B: from 0.1 to 8 parts by weight, preferably from 1 to 7 parts by weight; component C: from 80 to 120 parts by weight, in particular from 90 to 110 parts by weight, particularly preferably from 98 to 102 parts by weight. After drying of the film-like composition, i.e. after removal of the component C, the proportions by weight alter correspondingly. In a preferred embodiment, the weight ratio of the component A to the component B is more than 60:40, in particular more than 70:30.

In a further preferred embodiment of the invention, e.g. when using a bentonite as component B, the film-like composition has the following weight ratios: component A: from 20 to 35 parts by weight, in particular from 25 to 30 parts by weight, particularly preferably up to 28 parts by weight; component B: from 5 to 8 parts by weight, preferably from 6 to 7 parts by weight; component C: from 80 to 120 parts by weight, in particular from 90 to 110 parts by weight, particularly preferably from 98 to 102 parts by weight. After drying of the film-like composition, i.e. after removal of the component C, the proportions by weight alter correspondingly. In a preferred embodiment, the weight ratio of the component A to the component B is more than 60:40, in particular in the range from about 70:30 to 90:10.

In a further preferred embodiment of the invention, in particular when using hectorite as sorbent or binder, the film-like composition has the following weight ratios: component A: from 20 to 50 parts by weight, in particular from 25 to 45 parts by weight, particularly preferably from 30 to 42 parts by weight; component B: from 0.1 to 5 parts by weight, preferably from 1 to 3 parts by weight; component C: from 80 to 120 parts by weight, in particular from 90 to 110 parts by weight, particularly preferably from 98 to 102 parts by weight. After drying (and if appropriate activation) of the film-like composition, i.e. after removal of the component C, the proportions by weight alter correspondingly.

Thus, the dried or activated film-like composition has a water content of preferably less than about 10% by weight, in particular less than about 5% by weight, more preferably less than about 2% by weight. The preferred proportions by weight of the components A and B in the dried or activated composition are then from 52 to 132 parts by weight, in particular from 65 to 119 parts by weight, more preferably from 79 to 111 parts by weight, for component A and from 0.2 to 14 parts by weight, in particular from 2 to 8 parts by weight, for component B.

The compositions of the invention can be applied in various ways to the support materials. e.g. the materials used for sealing of electroluminescent or other electronic components. Application can be carried out by methods with which those skilled in the art are familiar, e.g. casting, dispensing, doctor blade coating, spin coating or printing, in particular screen printing, rolling or the like. The compositions of the invention are converted into sorbent films after application and removal of the liquid phase.

Depending on the type and amount of the sorbents and binders used, the compositions or sorbent films according to the invention may have to be activated before use. In one embodiment of the invention, the film-like composition is activated before or after application to the substrate or the support. Activation is particularly preferably effected in an activation step after application to the support or the substrate. Here, drying of the film-like composition can also be carried out simultaneously with activation. Activation can be effected in ways with which those skilled in the art are familiar, for example by heating in an oven, IR irradiation, UV irradiation or other methods which appear suitable to those skilled in the art. Microwave energy can also be used advantageously for activation. Here, the composition of the invention or the sorbent film is irradiated with microwaves having a wavelength which is absorbed by water molecules. Microwave activation is preferably carried out under reduced pressure or under an inert gas. The preferred quantity of microwave energy per gram of the composition of the invention or the sorbent film is preferably in the range from about 50 W to 5 kW, but can also be higher or lower depending on the activation time and temperature. The microwave radiation preferably has a wavelength in the range from 1 mm to 15 cm (frequency: from 3×10¹¹ to 2×10⁹ Hz). Activation can also be carried out under reduced pressure and/or at elevated temperature (above room temperature).

In one embodiment of the invention when using zeolite as sorbent, the composition of the invention is activated at a temperature of above 570° C. in order to be able to optimally utilize the uptake capacity of the zeolite A which is preferably used. The use of this temperature for drying of the sorbent film is preferred when the substrate used does not suffer damage at temperatures above 570° C. If drying of the film at T=570° C. is not possible for the above-mentioned reasons, the drying temperature can be reduced, e.g. to about 350-450° C. Lower temperatures can also be used; in a preferred embodiment, they are in the range from about 120 to 150° C. when using zeolite. In an embodiment of the invention, the activation is preferably carried out under reduced pressure. The application of vacuum allows the desired adsorption properties of the film to be obtained at temperatures of about 200° C. upwards. The highest possible temperature for the activation of the film depends on the following parameters: thermal stability of the substrate; thermal expansion of the substrate during heating and cooling of the substrate; thermal stability of the binder and sorbent. If the coefficient of thermal expansion of the substrate is too high, the thermal expansion can lead to detachment of the film from the substrate surface, especially during cooling.

Depending on the substrate chosen, the activation temperature for the sorbent film can be adapted in a suitable way. The preferred activation temperatures of the respective substrates (and sorbents) are well-known to those skilled in the art or can easily be determined by means of routine tests. At activation temperatures lower than T=570° C., the activation time can be increased and, in addition, vacuum can be applied to accelerate the drying process.

The activation parameters are naturally also dependent on the choice of binder. It has surprisingly been found that porous but nevertheless firmly adhering films can be produced on supports such as glass substrates even at relatively low temperatures when sheet silicates are used.

The compositions and sorbent films of the invention preferably have a high proportion of active sorbent, are very thin, homogeneous and display a high adsorption rate and adsorption capacity for moisture at a very low partial pressure of water vapour in the environment.

The compositions and sorbent films of the invention are able to sorb not only water vapour but also other gases (ammonia, amines, oxygen). Since they have a high sorption capacity, the electronic device in which they are used does not have to be sealed in a completely airtight manner, i.e. the diffusion rate for water vapour into the device may be greater than 0. In addition, the choice of a suitable material for sealing of the device, e.g. an epoxy resin, is simplified since the critical time by which this material has to have achieved its final low permeability to water vapour can be increased by the use of the sorbent film.

To set favourable flow properties for the method of application selected in the particular case (e.g. casting, dispensing, spin coating, doctor blade coating, printing processes, in particular screen printing), a rheological additive can be added to the mixture. The additives with which those skilled in the art are familiar (e.g. smectites, precipitated silica, pyrogenic silica) can be used for this purpose. The use of smectitic clay, in particular bentonite, has been found to be particularly advantageous, since this can act simultaneously as binder and rheological additive.

In general, additional components which may be present in the composition of the invention can be selected, for example, from the group consisting of fluidizers, sintering aids, rheological additives, pigments and preservatives. Such substances are well-known to those skilled in the art and therefore do not have to be described in more detail at this point.

The compositions of the invention can also be protected against attack by microorganisms by addition of a biocide. These agents such as Parmetol K40 or Acticid LV706 are used in a very low concentration, e.g. about 0.1% based on the total mixture.

In a further preferred embodiment, a glass solder, in particular a boron-free glass solder, is used in the composition of the invention, preferably in an amount of up to 10% by weight, particularly preferably in the range from about 1 to 7% by weight. The adhesion properties, in particular to glass supports, can frequently be improved further in this way. The glass solder should preferably melt at temperatures of not more than 550° C., in particular not more than 480° C., preferably in the range from about 460 to 480° C. Some preferred glass solders have, for example, a transformation temperature of from about 300 to 330° C., in particular from 305 to 315° C. Above the transformation temperature, the glass solders become soft. As a result, the particles in the composition stick to one another and good bonding to the substrate is ensured.

In a further preferred embodiment, a water glass is used in the composition of the invention, in particular in an amount of up to 1% by weight, particularly preferably up to 0.7% by weight, based on the amount of sorbent used, in particular zeolite used. In a particularly preferred embodiment, a sodium borate is used. The film-like compositions according to the invention with an addition of sodium borate display both particularly good adhesion properties and moisture absorption properties. Preference is given to using sodium borate in an amount from about 0.1 to 3% by weight, in particular from about 0.2 to 2%, based on the total composition.

In a further aspect, the present invention provides a process for producing a sorbent-containing film or an assembly comprising a sorbent-containing film on a support or substrate, which comprises the following steps:
preparation of a mixture of at least one sorbent, a natural or synthetic sheet silicate and a liquid phase in the form of a suspension having a viscosity as described above, preferably in the range from 10 to 7000 mPas, in particular from 10 to 3000 mPas, at a shear rate of 100 s⁻¹;
application of the suspension as film or layer to a substrate or a support;
solidification of the film or the layer on the substrate or the support; and
   if desired, activation of the sorbent in the solidified film or the layer.

The surface for application of the composition of the invention is provided by means of a support or a substrate.

The components A, B and C can be mixed in any order. The component B is preferably added as last component in the preparation of the mixture.

In one embodiment of the invention, the substrate or the surface is brought to an elevated temperature, preferably in the range from 50 to 95° C., in particular from 60 to 70° C., prior to application of the suspension.

In a further aspect, the present invention provides an electronic device or component, in particular an electroluminescent component such as an OLED display or panel, a polymeric light-emitting component, CCD sensors (charge-coupled devices) or microelectromechanical sensors (MEMSs), containing a film-like composition according to any of the attached claims or able to be prepared by a process according to any of the attached claims. It has been found that the film-like compositions or sorbent films of the invention can be used particularly advantageously in the above (micro)electronic devices or components since they can be made available as very thin, homogeneous firmly adhering sorbent films having a high absorption rate and absorption capacity for moisture even at a very low partial pressure of water vapour in the environment.

The (micro)electronic devices or components are, for example, hermetically sealed in a capsule by a substrate of the OLED being joined to the capsule element so that the microelectronic elements are enclosed in a watertight capsule. The substrate of the OLED can, for example, be joined by means of a suitable adhesive or any other method which is known from the production of electronic components. A suitable adhesive is, for example, an epoxy resin.

The above-described production steps are all part of the usual knowledge of a person skilled in the field of the production of electronic components and are carried out in a customary fashion. The film-like composition can be located on the substrate of the OLED and/or the microelectronic elements and/or the capsule element.

A further aspect of the present invention therefore provides for the use of a film-like composition as described above or able to be produced by a process according to any of the attached claims as coating or film which is present on a substrate or a surface and absorbs moisture and/or other volatile substances such as aromatics.

A further aspect accordingly provides an assembly comprising a support or substrate onto which a film-like composition or layer (sorbent-containing film) as described herein has been applied directly and adheres. In a preferred embodiment, the support or substrate can be the interior surface of a capsule which hermetically encapsulates an electronic component or its microelectronic elements. The application and, if appropriate, activation of the film-like composition can then be effected before sealing of the electronic component, with the film-like composition being located on a section of the interior surface of the capsule in such a way that it is in juxtaposition with the moisture-sensitive microelectronic elements in the hermetically sealed capsule and can effectively protect them from moisture. Examples of possible arrangements within the electronic components may be found, for example, in the abovementioned US 2003/0037677 A1, which is hereby expressly incorporated by reference.

### Methods:

The viscosity of the pastes or suspensions or dispersions was measured in accordance with DIN 53019/ISO 3219. This was carried out using a RheoStress 600 rheometer from Haake in accordance with the manufacturer's instructions.

The swellability was determined as follows: a calibrated 100 ml measuring cylinder is filled with 100 ml of distilled water. 2.0 g of the substance to be measured are added slowly in portions of 0.1-0.2 g onto the water surface. After the material has settled, the next portion is added. After the addition is complete, the contents of the cylinder are allowed to stand for 1 hour and the volume of the swollen substance is then read off in ml/2 g.

The determination of the BET surface area was carried out in accordance with DIN 66131. The porosity was determined as the pore size average pore diameter (4V/A by BET).

The determination of the particle size was carried out using a Mastersizer S Ver. 2.17 (Malvern Instruments GmbH, Herrenberg, Germany) in accordance with the manufacturer's instructions. The D50 and D90 values reported are in each case based on the sample volume. The measurement was carried out in water.

The determination of the ion exchange capacity (IEC) was carried out by the ammonium chloride method, as follows: 5 g of clay are sieved through a 63 μm sieve and dried at 110° C. Exactly 2 g are then weighed into a conical ground-joint flask in a difference weighing on an analytical balance and admixed with 100 ml of 2N NH₄Cl solution. The suspension is refluxed for one hour. After being allowed to stand for about 16 hours, the NH₄⁺-bentonite is filtered off on a membrane suction filter and washed with deionized water (about 800 ml) until largely free of ions. The freedom from ions of the washing water is established by detection of NH₄⁺ ions by means of the Nessler's reagent (from Merck, catalogue No. 9028) which is sensitive to these. The washing time can vary from 30 minutes to 3 days, depending on the type of clays. The washed NH₄⁺-bentonite is taken from the filter, dried at 110° C. for 2 hours, milled, sieved (63 μm sieve) and once again at 110° C. for 2-hours. The NH₄⁺ content of the bentonite is then determined by the Kjeldahl method. The IEC of the clay is the NH₄⁺ content of the NH₄⁺-bentonite determined by the Kjeldahl method (reported in meq/100 g of clay).

The cations liberated in the exchange are present in the washing water and can be determined by means AAS (atomic absorption spectrometry). The washing water is evaporated, transferred to a 250 ml volumetric flask and made up to the mark with deionized water. In the case of sodium, the following measurement conditions are selected:

| | |
|---|---|
| Wavelength (nm) | 589.0 |
| Slit width (nm) | 0.2 |
| Integrated time (sec.) | 3 |
| Flame gases | air/C₂H₂ |
| Background compensation | none |
| Type of measurement | conc. |
| Ionization buffer | 0.1% KCl |
| Calibration standards (mg/l) | 1-5 |

The IEC is reported in meq/100 g of clay.

The invention is illustrated below with reference to examples and with the aid of the accompanying drawings, with FIG. 1 schematically showing an electronic component which has been produced using the film-like composition of the invention.

### EXAMPLES

### Example 1

680 g of zeolite 4A (water content: 11.9%) is stirred into 2.5 l of water. 170 g of bentonite (water content: 9.3%, Na-bentonite, D₅₀=4.4 μm) is subsequently added and dispersed using a high-shear stirrer (Ultra-Turrax stirrer) for 10 minutes.

### Example 2

680 g of zeolite 4A (water content: 11.9%) is stirred into 2.5 l of water. 120 g of bentonite (water content: 9.3%, see above) is subsequently added and dispersed using a high-shear stirrer (Ultra-Turrax stirrer) for 10 minutes.

The viscosity of the samples from the above examples was measured at shear rates of 1 s⁻¹, 10 s⁻¹, 100 s⁻¹ and 1000 s⁻¹ (results reported in Pa*s)

| Example | 1 | 2 |
|---|---|---|
| 1 s⁻¹ | 106 | 0.55 |
| 10 s⁻¹ | 9.6 | 0.14 |
| 100 s⁻¹ | 1.6 | 0.05 |
| 1000 s⁻¹ | 0.19 | 0.03 |

After storage of the samples from the above examples at 40° C. for 6 weeks, the syneresis was determined. Here, the sample from Example 1 displayed no syneresis, while the sample from Example 2 had a small syneresis (<10%).

The samples from the above examples were introduced by means of a pipette into glass cavities having dimensions of 45 mm×29 mm×0.4 mm. They were subsequently dried at room temperature and the film formation and adhesion were evaluated.

The samples from both examples displayed good film formation and adhered well to the glass support.

As an alternative, 5-10 g of the samples (pastes) from Examples 1 and 2 were in each case placed in a porcelain dish and treated thermally at 200° C. or 400° C. for 1 hour in a drying oven.

The thermally treated samples were subsequently cooled to room temperature in a desiccator and then transferred to a controlled-atmosphere cabinet at 25° C. and 40% r.h. (relative humidity) to check the water uptake. The samples dried at 200° C. displayed a moisture uptake capacity of up to 12%.

The samples dried at 400° C. all displayed a moisture uptake capacity in the range from 14 to 16%. The full moisture uptake capacity was able to be achieved after a few hours in the controlled-atmosphere cabinet.

### Example 3

682 mg of the desiccant paste prepared in Example 1 is introduced into a glass cavity having the dimensions 45 mm×29 mm×0.4 mm. It is subsequently dried at 70° C. for one hour. The sample is then evacuated to a pressure of about 100 Pa and heated to 400° C. over a period of one hour. This temperature is maintained for 2 hours, and the sample is then cooled under reduced pressure over a period of one hour.

### Example 4

682 mg of the desiccant paste prepared in Example 1 is introduced into a glass cavity having the dimensions 45 mm×29 mm×0.4 mm. It is subsequently dried at 70° C. for one hour. The sample is then evacuated to a pressure of about 2 Pa and heated to 200° C. over a period of one hour. This temperature is maintained for 2 hours, and the sample is then cooled under reduced pressure over a period of one hour.

### Example 5

An organic electroluminescent component having dimensions of 45 mm×29 mm is produced using the component rear layer prepared in Example 3. For this purpose, the rear layer is fastened by means of an adhesive to the glass substrate of the component and sealed as far as possible. The size of the light-emitting pixels of the component is determined.

The component is subsequently subjected to conditions of 85° C. and 85% r.h. for 500 hours. After this time, the size of the light-emitting pixels and also the number of the nonemitting pixels (dark spots) is determined. It is found that no nonemitting pixels occur and the size of the pixels is unchanged compared to the initial component. Corresponding results were obtained when the experiment was repeated using the component rear layer prepared in Example 4.

### Example 6

240 g of zeolite 4A (water content: 11.9%) are stirred into 882 g of water. 60 g of bentonite (water content: 9.3%) and 4.8 g of glass solder (G 018/209 from Schott) are subsequently added and dispersed using a high-shear stirrer (Ultra-Turrax stirrer) for 10 minutes.

### Example 7

240 g of zeolite 4A (water content: 11.9%) are stirred into 882 g of water. 60 g of bentonite (water content: 9.3%) and 12 g of glass solder (G 018/209 from Schott) are subsequently added and dispersed using a high-shear stirrer (Ultra-Turrax stirrer) for 10 minutes.

The syneresis was determined as describe above for Examples 1 and 2. The samples from Examples 6 and 7 displayed no appreciable syneresis after storage at 40° C. for four weeks.

The desiccant pastes prepared in this way were subsequently applied and heat treated as described in Examples 3 and 4, with heat treatment being carried out at 480° C.

The samples from Examples 6 and 7 displayed very good adhesion to the glass support, with the sample from Example 7 displaying the best adhesion.

Both samples displayed moisture uptake capacities of more than 14% by weight after heat treatment at 480° C. (cf. above).

In summary, it can be said that the compositions from Examples 6 and 7 containing glass solder displayed no or very little syneresis, with very good bonding to the glass support being achieved at concentrations of 2% by weight and 5% by weight of glass solder and the moisture uptake capacity being in the range from 10 to 15%.

### Example 8

240 g of zeolite 4A (water content: 11.9%) are stirred into 882 g of water. 60 g of bentonite (water content: 9.3%) and 0.24 g of water glass are subsequently added and dispersed using a high-shear stirrer (Ultra-Turrax stirrer) for 10 minutes.

### Example 9

240 g of zeolite 4A (water content: 11.9%) are stirred into 882 g of water. 60 g of bentonite (water content: 9.3%) and 1.2 g of water glass are subsequently added and dispersed using a high-shear stirrer (Ultra-Turrax stirrer) for 10 minutes.

Samples from Examples 8 and 9 were applied to a glass support as described in Examples 3 and 4 and a heat treatment at 200° C. or 400° C. was carried out as described above.

Both the sample from Example 8 and the sample from Example 9 displayed very good adhesion to the glass support.

After heat treatment at 200° C., both samples displayed good moisture uptake capacities which were comparable with those of the samples from Examples 6 and 7. The sample dried at 400° C. in Example 9 had a maximum moisture uptake capacity of 17% by weight after heat treatment at 400° C.

### Example 10

680 g of zeolite 4A (water content: 11.9%) are stirred into 2.5 l of water. 300 g of kaolinite are subsequently added and dispersed using a high-shear stirrer (Ultra-Turrax stirrer) for 10 minutes.

### Example 11

680 g of zeolite 4A (water content: 11.9%) are stirred into 2.5 l of water. 84 g of hectorite are subsequently added and dispersed using a high-shear stirrer (Ultra-Turrax stirrer) for 10 minutes.

Application to the substrate and heat treatment were carried out on the samples of Examples 10 and 11 exactly as indicated in Examples 3 and 4. The sample from Example 11 exhibits a comparable syneresis, adhesion and moisture uptake capacity as in the other examples. The sample from Example 10 was somewhat poorer, but acceptable.

### Example 12

204 g of zeolite 4A (water content: 11.9%) are stirred into 743 g of water. 51 g of bentonite (water content: 9.3%) and 9 g of sodium borate are subsequently added and dispersed using a high-shear stirrer (Ultra-Turrax stirrer) for 10 minutes. Good layers could be produced from the paste in the manner described in Examples 3 and 4. Even after 4 weeks, no syneresis was found. The water uptake capacity was 14% by weight.

### Example 13

235 g of zeolite 4A (water content: 11.9%) are stirred into 500 g of H₂O+preservative (1 g of Acticide LV 706, Thor GmbH, Germany) by means of a high-speed stirrer. 20.4 g of a synthetic hectorite are subsequently dissolved in 250 g of H₂O and added to the zeolite suspension. This gives a viscous paste. Glass solder (5.1 g of glass No. G018-209, from Schott, Germany) is subsequently added. The viscosity of the paste decreases slightly as a result. The paste is stirred by means of a high-speed stirrer for a further 10 minutes. Layers displaying good absorption and very good adhesion could be produced from the paste in the manner described in Examples 3 and 4. Even after 4 weeks, no syneresis was found. The water uptake capacity was 16% by weight.

### Example 14

240 of zeolite 4A (water content: 11.9%) are stirred into 400 g of H₂O+preservative (1 g of Acticide LV 706, Thor GmbH, Germany) by means of a high-speed stirrer. 15.3 g of a synthetic hectorite are subsequently dissolved in 350 g of H₂O and added to the zeolite suspension. This gives a viscous paste. 9 g of sodium borate are subsequently added. The paste is stirred by means of a high-speed stirrer for a further 10 minutes. Layers displaying good absorption and very good adhesion could be produced from the paste in the manner described in Examples 3 and 4. Even after 4 weeks, no syneresis was found. The water uptake capacity was 16% by weight.

### Example 15

695 mg of the pastes from the above examples were introduced by means of a pipette into glass depressions having a size of 45 mm×29 mm×0.4 mm. The sample was placed in a 700 W microwave oven for 5 minutes. To produce an OLED, the glass substrate was fixed to a glass substrate on which microelectronic elements were located in order to form the rear layer of the electronic component. The electronic component is shown schematically in FIG. 1. Microelectronic elements 2 are located on a glass substrate 1 so as to form an OLED. The electronic elements encompass a cathode 3, an anode 4 and an organic light-emitting layer 5. A capsule-like cap 6 is located on the glass substrate 1. The substrate 1 and the cap 6 are joined along their outer edges by means of an epoxy adhesive 7 so as to form a watertight capsule 8. On an interior surface of the capsule 8, a desiccant film 9 is located on the interior surface of the cap 6.

The size of the light-emitting pixels was measured and the electronic component was then stored in a controlled-atmosphere chamber at 85° C. and 85% r.h. for 500 hours. The size of the light-emitting pixels was measured again and the number of dark spots was determined. It was found that no dark spots occurred and that the size of the light-emitting pixels was the same as at the beginning of the experiment.

1. A film-like composition, in particular for moisture-sensitive electronic components or devices, comprising:
a) at least one sorbent (component A);
b) at least one natural or synthetic sheet silicate (component B); and
c) optionally a liquid phase (component C),
where the composition has not been pressed or compressed.

2. The film-like composition according to claim 1, characterized in that the sorbent is an inorganic sorbent.

3. The film-like composition according to claim 1, characterized in that components A, B and C are present in the following weight ratios:
a) component A: from 20 to 35 parts by weight,
b) component B: from 5 to 8 parts by weight,
c) component C: from 80 to 120 parts by weight.

4. The film-like composition according to claim 1, characterized in that the components A, B and C are present in the following weight ratios:
a) component A: from 20 to 50 parts by weight,
b) component B: from 0.1 to 5 parts by weight,
c) component C: from 80 to 120 parts by weight.

5. The film-like composition according to claim 1, characterized in that the natural or synthetic sheet silicate comprises a smectitic clay, such as bentonite or hectorite.

6. The film-like composition according to claim 5, characterized in that the smectitic clay comprises a sodium-containing bentonite or a synthetic hectorite.

7. The film-like composition according to claim 1, characterized in that the natural or synthetic sheet silicate has a swellability of at least 15 ml/2 g.

8. The film-like composition according to claim 1 further comprising additional components selected from the group consisting of fluidizers, sintering aids, rheological additives, pigments and preservatives and mixtures thereof.

9. The film-like composition according to claim 1, further comprising a rheological additive selected from a sheet silicate, such as hectorite, a precipitated silica, a pyrogenic silica, and mixtures thereof.

10. The film-like composition according to claim 1, further comprising up to 10% by weight of a glass solder.

11. The film-like composition according to claim 1, further comprising up to 1% by weight of water glass, based on the amount of sorbent used.

12. The film-like composition according to claim 1, further comprising up to 10% by weight sodium borate, based on the amount of sorbent used.

13. The film-like composition according to claim 1, characterized in that the film-like composition has a thickness in the range from 1 μm to 10 mm.

14. A composition comprising the film-like composition according to claim 1 applied to a substrate or a surface or adhered thereto, without use of a separate adhesive.

15. The composition of claim 14 wherein the substrate or the surface is selected from the group consisting of a metal, a plastic and a glass.

16. The film-like composition of claim 1, characterized in that its mean pore diameter is in the range from about 3 to 15 nm, determined as the pore size average pore diameter (4V/A by BET).

17. (canceled)

18. A process for producing a sorbent-containing film which comprises the following steps:
a) preparation of a mixture of at least one sorbent, a natural or synthetic sheet silicate and a liquid phase in the form of a suspension having a viscosity in the range from 10 to 7000 mPas, at a shear rate of 100 s⁻¹;
b) application of the suspension to a substrate or a surface to form a film;
c) solidification of the film on the substrate, and
d) activation of the sorbent in the solidified film.

19. The process according to claim 18, characterized in that its viscosity is in the range from 100 to 1000 mPas, at a shear rate of 100 s⁻¹.

20. The process according to claim 18, characterized in that the application of the suspension to the substrate is carried out by a process selected from spin coating, spraying on or spray coating, painting, casting, doctor blade coating, printing processes, such as screen printing, and dip coating.

21. The process according to claim 18, characterized in that the natural or synthetic sheet silicate is added as the last component in the preparation of the mixture.

22. The process according to claim 18 further comprising activating the sorbent at a temperature of at least about 200° C., for a period of time from 0.5 to 10 hours.

23. The process according to claim 18, characterized in that the substrate or the surface is brought to an elevated temperature in the range from 50 to 95° C., prior to application of the suspension.

24. An electronic device or component, such as an electroluminescent component, such as an OLED display, containing the film-like composition according to claim 1.

25. (canceled)

26. (canceled)

27. A film-like composition, in particular for moisture-sensitive electronic components or devices, comprising:
a) at least one sorbent (component A);
b) at least one natural or synthetic sheet silicate (component B); and
c) optionally, a liquid phase (component C), where the composition has not been pressed or compressed and wherein the composition does not contain any organic solvent or binder.

28. The film-like composition of claim 27 wherein the composition does not contain any organic components.
